(19) United States
(12) Patent Application Publication
(10) Pub. No.: US 2007/0180208 A1
(43) Pub. Date: Aug. 2, 2007

(54) Preventive measure against data overflow from differential volume in differential remote copy

(76) Inventor: Yasuo Yamasaki, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/384,251

(22) Filed: Mar. 21, 2006

(30) Foreign Application Priority Data
Jan. 30, 2006 (JP) 2006-020535

(51) Int. Cl. G06F 12/16; G06F 13/00

(52) U.S. Cl. 711/162; 711/167

(57) ABSTRACT

In a computer system that executes remote copy of differential data between snapshots, data overflow in a differential volume of a secondary site is prevented when update data of a primary volume increases in amount. A controller of a primary site predicts whether or not data overflow happens in the differential volume of the secondary site and, predicting that data overflow happens, delays data write processing in which a host computer writes data in the primary volume by a given period of time.

### CLAIM OF PRIORITY

The present application claims priority from Japanese application JP2006-20535 filed on Jan. 30, 2006, the content of which is hereby incorporated by reference into this application.

### BACKGROUND

The technology disclosed in this specification relates to a storage system, and more specifically to data copy executed between plural storage systems.

The use of remote copy technologies for disaster recovery is expanding in recent storage systems. Disaster recovery is for enabling a business to continue despite a failure due to natural disasters or the like by remote-copying data of a site that is in operation (primary site) to a remote site (secondary site) in advance.

The only subject of remote copy in computer systems and the like of the past was database processing for a mission-critical operation, the most important operation of all to continue the business. Lately, however, non-database processing for peripheral operations is beginning to be counted in as a remote copy subject in order to further shorten the length of time in which the provision of a service is halted by a failure or the like. In remote copy for a mission-critical operation, it is common to avoid copy delay and resultant missing of data by employing synchronous remote copy that uses an expensive, dedicated line for instantaneous transfer of update data. On the other hand, in an operation that is not a mission-critical operation, missing of the latest data is more tolerable than in database processing. It is therefore common for an operation that is not a mission-critical operation to reduce communication cost by employing asynchronous copy that transfers update data via an intermediate volume. This asynchronous copy method is divided into two types, one being a journal volume method, which accumulates update data in an intermediate volume, the other being a differential snapshot copy method, which uses differential snapshot technologies to accumulate differential data in an intermediate volume. According to these methods, a shortage of intermediate volumes is often solved by expanding existing intermediate volumes or by delaying access to an operational volume (see US 2005/0257014 A, for example).

### SUMMARY

In the journal volume method, an operational volume (or its mirror volume) and an intermediate volume coexist in each storage system, and the storage systems monitor their own intermediate volumes for a shortage independent of each other, thereby achieving efficient monitoring.

In the differential snapshot copy method, a copy destination storage system sometimes holds snapshots of more generations than those held in a copy source storage system. When it is the case, there is a possibility that data overflows from a differential volume (i.e. an intermediate volume that accumulates differential data) in the copy destination storage system before data overflows from a differential volume in the copy source storage system. It is therefore necessary to execute monitoring of an operational volume in a copy source storage system and monitoring of a differential volume in a copy destination storage system concurrently without delay.

According to a representative aspect of the present invention, there is provided a computer system including: a host computer; a first storage system coupled to the host computer; and a second storage system coupled to the first storage system, in which: the first storage system includes a first volume, a second volume, and a first controller, the first volume storing data that is written by the host computer, the second volume storing data that has been stored in a block in the first volume when the block is to be updated, the first controller controlling the first storage system; the second storage system includes a third volume, a fourth volume, and a second controller, the third volume storing data that is copied from the first volume, the fourth volume storing data that has been stored in a block in the third volume when the block is to be updated, the second controller controlling the second storage system; and the first controller predicts whether or not the fourth volume becomes short of capacity and, predicting that the fourth volume becomes short of capacity, delays data write processing in which the host computer writes data in the first volume by a given period of time.

According to an embodiment of this invention, a copy source storage system can accurately predict data overflow of a differential volume in a copy destination storage system before it actually happens and can execute processing for preventing the overflow.

### BRIEF DESCRIPTION OF THE DRAWINGS

FIG. 1 is a block diagram of a computer system according to an embodiment of this invention.

FIG. 2 is a block diagram showing in detail the internal configuration of a storage system according to the embodiment of this invention.

FIG. 3 is an explanatory diagram of an overflow monitoring table according to the embodiment of this invention.

FIG. 4 is an explanatory diagram of a differential management table according to the embodiment of this invention.

FIG. 5 is an explanatory diagram of differential snapshots created in the computer system according to the embodiment of this invention.

FIG. 6 is a flow chart for a snapshot transferring program according to the embodiment of this invention.

FIG. 7 is a flow chart for an access monitoring program according to the embodiment of this invention.

FIG. 8 is a flow chart for a differential monitoring program according to the embodiment of this invention.

FIG. 9 is a flow chart for an intermediate snap deleting program according to the embodiment of this invention.

FIG. 10 is a flow chart for a differential volume expanding program according to the embodiment of this invention.

FIG. 11 is an explanatory diagram of remote copy preparations according to the embodiment of this invention.

FIG. 12 is an explanatory diagram of remote copy operation according to the embodiment of this invention.

FIG. 13 is an explanatory diagram of overflow monitoring according to the embodiment of this invention.

### DETAILED DESCRIPTION OF THE PREFERRED EMBODIMENTS

An embodiment of this invention will be described below with reference to the accompanying drawings.

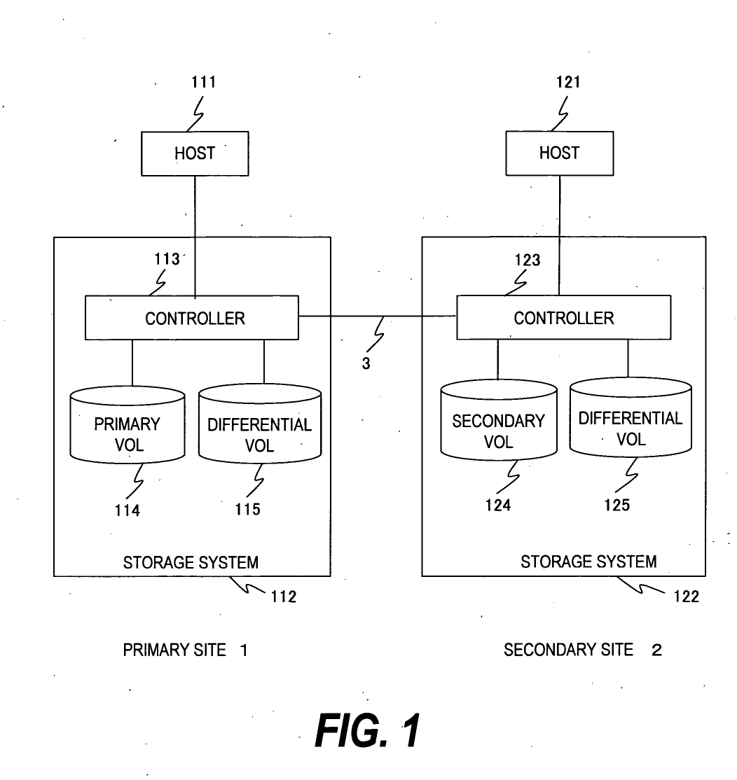

FIG. 1 is a block diagram of a computer system according to the embodiment of this invention.

The computer system of this embodiment has a primary site 1 and a secondary site 2, which are connected to each other via a network 3.

The main component of the primary site 1 is a storage system 112 accessed by a host 111. The host 111 implements various operations including database processing by executing application programs (omitted from the drawing). In executing an application program, the host 111 sends a read request or a write request to the storage system 112 to send/receive data to/from the storage system 112, or issues a snapshot transfer command to the storage system 112, as necessary.

The storage system 112 of the primary site 1 sends a differential copy via the network 3 to a storage system 122 of the secondary site 2. The storage system 122 is a backup of the storage system 112. In the event of a failure in the primary site 1, fail over processing is executed to hand over an operation that has been handled by the primary site 1 to the secondary site 2. Taking over the operation of the primary site 1, a host 121 of the secondary site 2 accesses the storage system 122 and executes the same operation that has been implemented by the host 111.

The storage system 112 of the primary site 1 and the storage system 122 of the secondary site 2 are connected to each other via the network 3. The storage system 112 of the primary site 1 has a controller 113, a primary volume 114 and a differential volume 115, which are interconnected inside the storage system 112. The storage system 122 of the secondary site 2 is similar to the storage system 112 of the primary site 1, and has a controller 123, a secondary volume 124, and a differential volume 125. The network 3 is, for example, an IP network.

The primary volume 114, the secondary volume 124, the differential volume 115, and the differential volume 125 are logical volumes. A logical volume is a storage area set in a storage system. For instance, in the case where the storage systems 112 and 122 each have one or more disk drives (omitted from the drawing), each logical volume is composed of one or more disk drives' storage area.

In the following description, the primary volume 114 and the secondary volume 124 are also referred to as operational volumes.

The storage system 112 of the primary site 1 and the storage system 122 of the secondary site 2 communicate with each other via the network 3 to make a disaster recovery system. Data stored in the primary volume 114 of the storage system 112 of the primary site 1 is, as will be described later, transferred to and stored in the storage system 122 of the secondary site 2 through differential remote copy using snapshot.

This embodiment attains the object of solving a shortage of free capacity in the differential volume 125 of the secondary site 2 and thus avoiding data overflow in the differential volume 125. The free capacity of a logical volume is a part of the capacity set to the logical volume that is yet to be consumed for data storage (in other words, a capacity that can be used for future data storage).

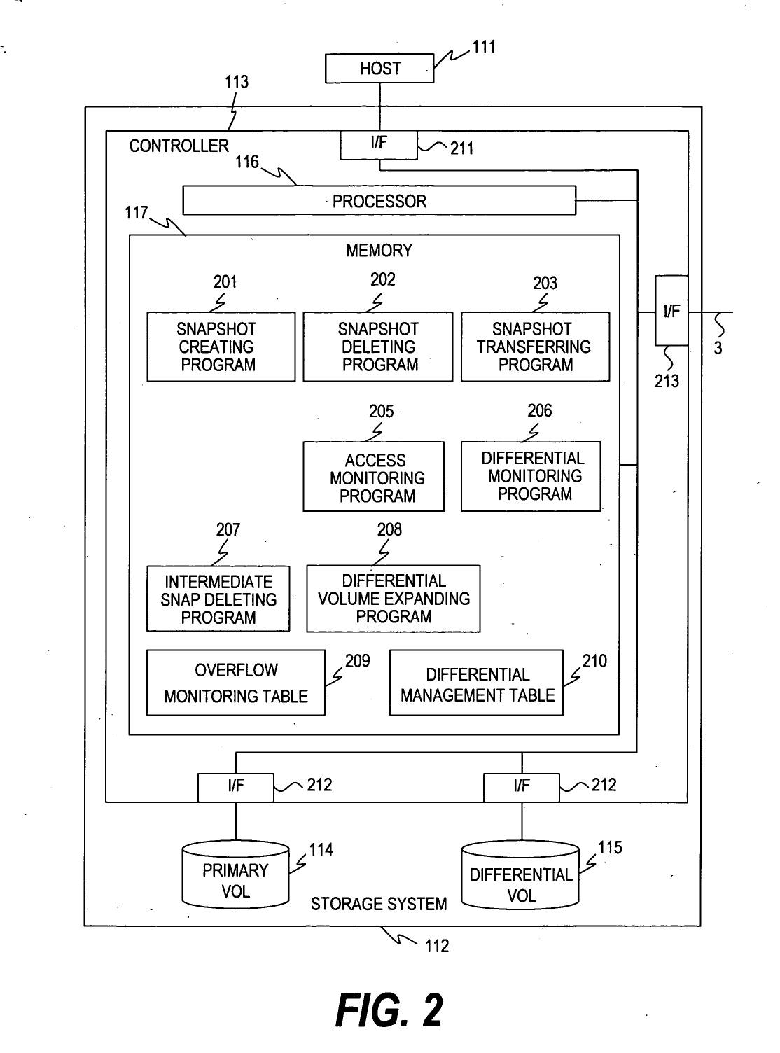

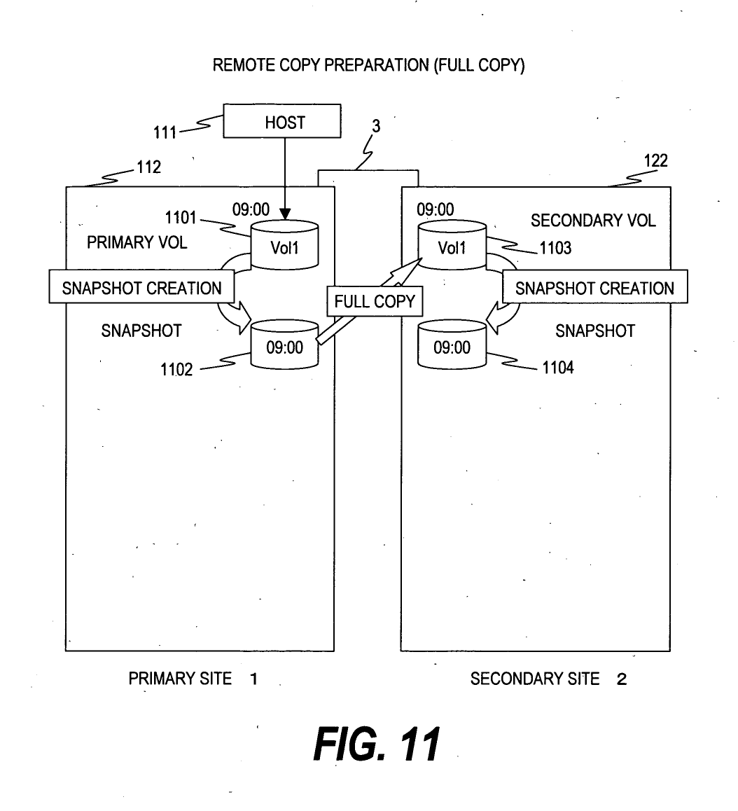

Next, details of the storage systems 112 and 122 will be described with reference to FIGS. 2 to 10. It will be followed by a description that is given with reference to FIGS. 11 to 13 on remote copy operation using the storage systems 112 and 122, and on the position of avoidance of overflow in the remote copy operation. The storage system 112 of the primary site 1 and the storage system 122 of the secondary site 2 have similar configurations, and therefore the configuration of the storage system 112 alone will be described while omitting a description on the configuration of the storage system 122.

FIG. 2 is a block diagram showing a detailed internal configuration of the storage system 112 according to the embodiment of this invention.

The controller 113 is a device for controlling the storage system 112, and has an interface (I/F) 211, an I/F 212, an I/F 213, a processor 116, and a memory 117, which are connected to one another. The I/F 211 is connected to the host 111 to send/receive data to/from the host 111. The I/F 212 is connected to the primary volume 114 or the differential volume 115 to send/receive data to/from the connected logical volume. The I/F 213 is connected via the network 3 to the controller 123 in the storage system 122 of the secondary site 2, and sends/receives data to/from the controller 123. The processor 116 executes programs stored in the memory 117. The memory 117 stores programs executed by the processor 116, and tables consulted by these programs.

The memory 117 in this embodiment stores, at least, a snapshot creating program 201, a snapshot deleting program 202, a snapshot transferring program 203, an access monitoring program 205, a differential monitoring program 206, an intermediate snap deleting program 207, and a differential volume expanding program 208. The memory 117 also stores an overflow monitoring table 209 and a differential management table 210.

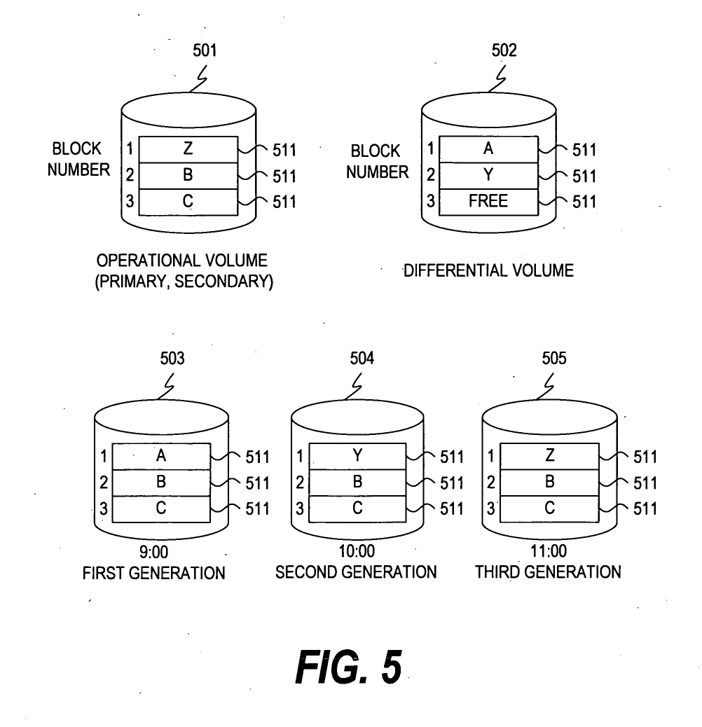

The snapshot creating program 201 follows an instruction from the host 11 and creates a snapshot of the primary volume 114 for differential management. In creating a snapshot, the snapshot creating program 201 stores in the differential volume 115 differential data that is the difference between the primary volume 114 and the snapshot. Differential snapshots created in this embodiment will be described later in detail with reference to FIG. 5.

The snapshot deleting program 202 follows an instruction from the host 111 and deletes a snapshot. In deleting a snapshot, the snapshot deleting program 202 deletes from the differential volume 115 differential data that is no longer necessary.

The snapshot transferring program 203 follows an instruction from the host 111 and transfers a differential snapshot to the storage system 122 of the secondary site 2.

The access monitoring program 205 registers in the overflow management table 209 the state of access from the host 111. When data is about to overflow from the differential volume 125 (in other words, when the differential volume 125 is about to be short of capacity), the access monitoring program 205 calls up the intermediate snap deleting program 207 or the differential volume expanding program 208 to have the program 207 or 208 execute processing that prevents overflow.

The differential monitoring program 206 monitors the differential volume 125 of the secondary site 2. Specifically, the differential monitoring program 206 of the secondary site 2 regularly checks the free capacity of the differential volume 125 and notifies the storage system 112 of the primary site 1 of the check result. Receiving the notification, the differential monitoring program 206 of the primary site 1 registers in the overflow monitoring table 209 a free capacity that is contained in the notification.

The intermediate snap deleting program 207 of the primary site 1 follows an instruction from the access monitoring program 205 and deletes an intermediate snapshot that is not indispensable for remote copy in the storage system 112 of the primary site 1. The term intermediate snapshot refers to one or more snapshots of intermediate generations, which are what remain after excluding snapshots of the oldest generation and of the latest generation. When an intermediate snapshot is deleted, data that constitutes the intermediate snapshot alone is deleted from the differential volume 115, and the amount of data transferred from the primary site 1 to the secondary site 2 is accordingly reduced. This means that less data is stored in the differential volume 125 of the secondary site 2, and data overflow is prevented as shown in FIG. 5.

Alternatively, the intermediate snap deleting program 207 of the secondary site 2 may delete an intermediate snapshot in the storage system 122 of the secondary site 2 in accordance with an instruction from the access monitoring program 205 of the primary site 1. As a result, data that constitutes the intermediate snapshot alone is deleted from the differential volume 125, and the free capacity of the differential volume 125 is thus increased.

The differential volume expanding program 208 follows an instruction from the access monitoring program 205 and expands the physical size of the differential volume 125 in the storage system 122 of the secondary site 2. The free capacity of the differential volume 125 is thus increased.

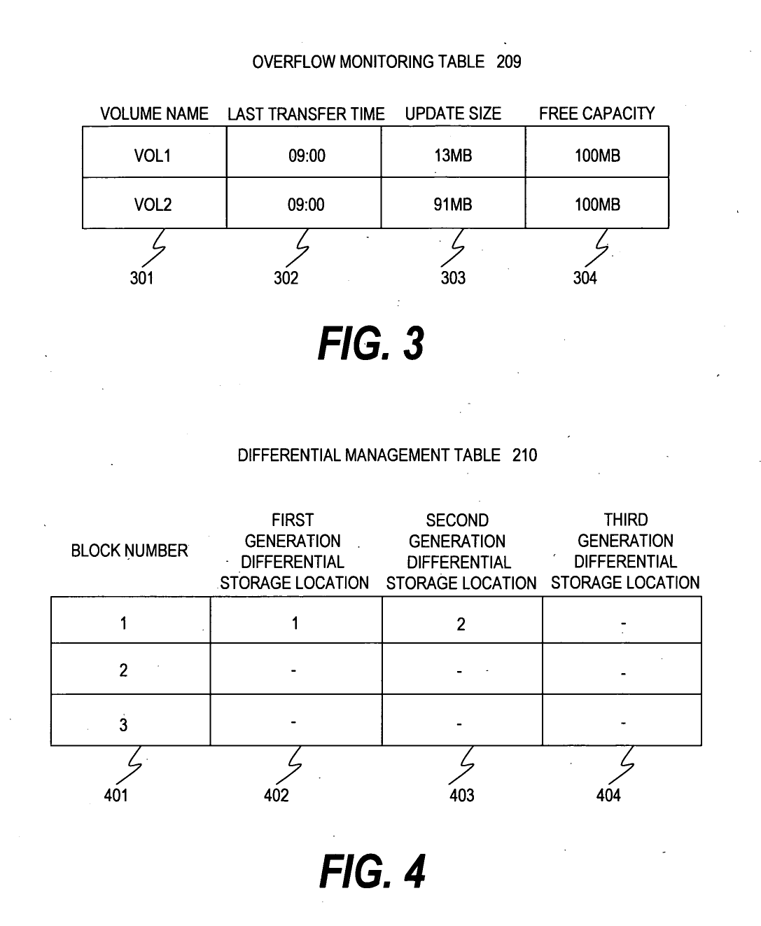

FIG. 3 is an explanatory diagram of the overflow monitoring table 209 according to the embodiment of this invention.

Each row of the overflow monitoring table 209 is composed of four fields for a volume name 301, a last transfer time 302, an update size 303, and a free capacity 304. As the volume name 301, the name of the primary volume 114 is registered. In the example of FIG. 3, “VOL1” and “VOL2” are registered as the volume name 301. This shows that the storage system 112 of the primary site 1 has two primary volumes 114 that are respectively given the names “VOL1” and “VOL2”. Registered as the last transfer time 302 is the time of creation of the latest snapshot that has finished being transferred from the primary site 1 to the secondary site 2. Registered as the update size 303 is the size of data that is yet to be transferred to the secondary site 2 among update data with which the primary volume 114 is updated (in other words, the size of data to be transferred to the secondary site 2 among data written in the primary volume 114). Registered as the free capacity 304 is the free capacity of the differential volume 125 in the secondary site 2.

For example, the first row in FIG. 3 shows that a snapshot that has been transferred last from the primary volume “VOL1” is created at 09:00, that the size of data yet to be transferred to the secondary site 2 among data written in “VOL1” after 09:00 is 13 megabytes (MB), and that the free capacity of the differential volume 125 of the secondary site 2 is 100 MB.

The primary site 1 uses the overflow monitoring table 209 to manage at which point in time the last snapshot transferred to the secondary site 2 is created, and the amount of yet-to-be-transferred update data with which the primary volume 114 is updated. The secondary site 2, on the other hand, uses the overflow monitoring table 209 to manage the free capacity of the differential volume 125. A comparison of information between the two overflow monitoring tables 209 makes it possible to detect data overflow. Instead of the name of a volume, other identifiers given to the volume may be used as the volume name 301.

A procedure for creating a differential snapshot will be described next with reference to FIGS. 4 and 5.

FIG. 4 is an explanatory diagram of the differential management table 210 according to the embodiment of this invention.

Shown in FIG. 4 as an example is the differential management table 210 of when snapshots of the first to third generations are created. Each row of the differential management table 210 in this case is composed of four fields for a block number 401, a first generation differential storage location 402, a second generation differential storage location 403, and a third generation differential storage location 404. In the case where snapshots of the fourth and subsequent generations are to be created, fields for a fourth generation differential storage location, a fifth generation differential storage location, a sixth generation differential storage location . . . (omitted from the drawing) are added to each row.

A block number assigned to a block of an operational volume is registered as the block number 401. The term block refers to a storage area of given capacity set in a logical volume (logical block). Each block of a logical volume is identified by a block number unique throughout the logical volume.

Registered as the first generation storage location 402 is a block number given to a block in a differential volume that stores differential data between a first generation snapshot and the current operational volume. The same principle applies to the second generation storage location 403 and the third generation storage location 404.

A more detailed description will be given with reference to FIG. 5 on an example of values registered in the differential management table 210.

FIG. 5 is an explanatory diagram of differential snapshots created in the computer system according to the embodiment of this invention.

FIG. 5 shows an operational volume 501, a differential volume 502, a first generation snapshot 503, a second generation snapshot 504, and a third generation snapshot 505. The snapshots 503, 504, and 505 are snapshots obtained as combinations of blocks stored in the operational volume 501 and the differential volume 502. The following description takes as an example a case in which the first generation snapshot 503 is created at 9:00, the second generation snapshot 504 is created at 10:00, and the third generation snapshot 505 is created at 11:00.

The operational volume 501 corresponds to the primary volume 114 or secondary volume 124 shown in FIG. 1 and other drawings. The differential volume 502 corresponds to the differential volume 115 or 125 shown in FIG. 1 and other drawings. In the case where the operational volume 501 corresponds to the primary volume 114, the differential volume 502 corresponds to the differential volume 115.

The operational volume 501 and the differential volume 502 in FIG. 5 are each composed of three blocks 511. Numerals to the left of the blocks 511 in the drawing are block numbers assigned to the respective blocks 511. In the following description, a block 511 that has a block number “1” is referred to as first block 511, a block 511 that has a block number “2” is referred to as second block 511, and a block 511 that has a block number “3” is referred to as third block 511. The block count of the operational volume 501 and the block count of the differential volume 502 are not limited to 3 each, but can be any number equal to or larger than 1.

At 9:00, value A data, value B data, and value C data have been stored in the first, second and third blocks 511 of the operational volume 501, respectively. In the differential volume 502, on the other hand, the first to third blocks 511 are free blocks at 9:00. In other words, no data has been stored in any of the blocks 511 of the differential volume 502 at this point.

The first generation snapshot is created at 9:00. At this point, the snapshot creating program 201 secures a field for the first generation differential storage location 402 in the differential management table 210 as shown in FIG. 4.

In the case where update data is written in one of the blocks 511 of the operational volume since a snapshot is created until a snapshot of the next generation is created, the update data is stored in this block 511 and data that has been stored in this block 511 at the time of creation of the current snapshot is evacuated to one of the blocks 511 of the differential volume 502. Then a block number assigned to the block 511 of the differential volume 502 that stores the evacuated data is registered in the field of the first generation storage location 402 in the differential management table 210.

To give a specific example, a value X is written in the first block 511 of the operational volume 501 at 9:10. To write the value X, the value A, which is data in the first block 511 of the operational volume 501 at the time the first generation snapshot has been created (9:00), is evacuated to the first block 511 of the differential volume 502. Then the block number “1” indicating the first block 511 of the differential volume 502 where the value A is now stored is registered as the first generation differential storage location 402 in an entry of the differential management table 201 that has, as the block number 401, “1” for the first block 511.

At 9:20, a value Y is written in the first block 511 of the operational volume 501. At this point, the value A has already been evacuated and accordingly the value Y is stored in the first block 511 of the operational volume 501 without updating the differential volume 502 and the differential management table 210.

At 10:00, the second generation snapshot is created. In creating this snapshot, the snapshot creating program 201 secures a field for the second generation differential storage location 403 in the differential management table 210.

Thereafter, a value Z is written in the first block 511 of the operational volume 501 at 10:10. To write the value Z, the value Y, which is data in the first block 511 of the operational volume 501 at the time the first generation snapshot has been created (10:00), is evacuated to the second block 511 of the differential volume 502. Then the block number “2” indicating the second block 511 of the differential volume 502 where the value Y is now stored is registered as the second generation differential storage location 403 in an entry of the differential management table 201 that has, as the block number 401, “1” for the first block 511.

At 11:00, the third generation snapshot is created. In creating this snapshot, the snapshot creating program 201 secures a field for the third generation differential storage location 404 in the differential management table 210. Values registered in the differential management table 210 shown in FIG. 4 are ones at 11:00 in the above example. Also, volume and snapshot values shown in FIG. 5 are ones at 11:00 in the above example.

The snapshots created as above are virtual, logical volumes constructed by combining the blocks 511 of the operational volume 501 and the blocks 511 of the differential volume 502 in accordance with the differential management table 210. In the above example, an entry of the differential management table 210 whose block number 401 is “1” has “1” as the first generation differential storage location 402, and entries of the differential management table 210 whose block number 401 is “2” and “3” have “-” (invalid value) as the first generation differential storage location 402. The first generation snapshot 503 in this case is composed of the first block 511 of the differential volume 502, the second block 511 of the operational volume 501, and the third block 511 of the operational volume 501. Values in these three blocks 511 are “A”, “B”, and “C”, respectively.

Similarly, the entry whose block number 401 is “1” has “2” as the second generation differential storage location 403. The second generation snapshot 504 in this case is composed of the second block 511 of the differential volume 502, the second block 511 of the operational volume 501, and the third block 511 of the operational volume 501. Values in these three blocks 511 are “Y”, “B”, and “C”, respectively.

There is no value registered as the third generation differential storage location 404 in any entry. Accordingly, the third generation snapshot 505 is the same as the operational volume 501.

Processing executed by the intermediate snap deleting program 207 will now be described. To delete the second generation snapshot 504, for example, differential data “Y”, which is needed only for creation of the second generation snapshot 504 and therefore no longer necessary, is deleted from the second block 511 of the differential volume 502 by the intermediate snap deleting program 207. After thus making the second block 511 of the differential volume 502 a “free” volume, the intermediate snap deleting program 207 registers “-” as the second generation differential storage location 403 in the differential management table 210. By deleting an intermediate snapshot in this way, data overflow of the differential volume 502 is prevented.

For instance, when differential copy processing is executed in the primary site 1 where the three generation snapshots shown in FIG. 5 have been created, the differential data “Y”, which is the difference between the first generation snapshot 503 and the second generation snapshot 504, is first transferred to the secondary site 2, and then the differential data “Z”, which is the difference between the second generation snapshot 504 and the third generation snapshot 505, is transferred to the secondary site 2. In the secondary site 2, the two data “A” and “Y”, which are overwritten with the transferred data, are stored in the differential volume 125.

However, in the case where the intermediate snap deleting program 207 deletes the second generation snapshot 504, only the differential data “Z”, which is the difference between the first generation snapshot 503 and the third generation snapshot 505, is transferred to the secondary site 2. Then the data “A”, which is overwritten with the data “Z”, is stored in the differential volume 125 whereas the untransferred data “Y” is not stored in the differential volume 125. In this way, deleting an intermediate snapshot reduces data to be stored in the differential volume 125 of the secondary site 2 and prevents data overflow.

On the other hand, in the case where the intermediate snap deleting program 207 is executed in the secondary site 2 where the three generation snapshots shown in FIG. 5 have been created, the second generation snapshot 504 is deleted. The data “Y” contained only in the second generation snapshot 504 is deleted from the differential volume 502 (i.e., the differential volume 125). The free capacity of the differential volume 125 is thus increased and data overflow is prevented.

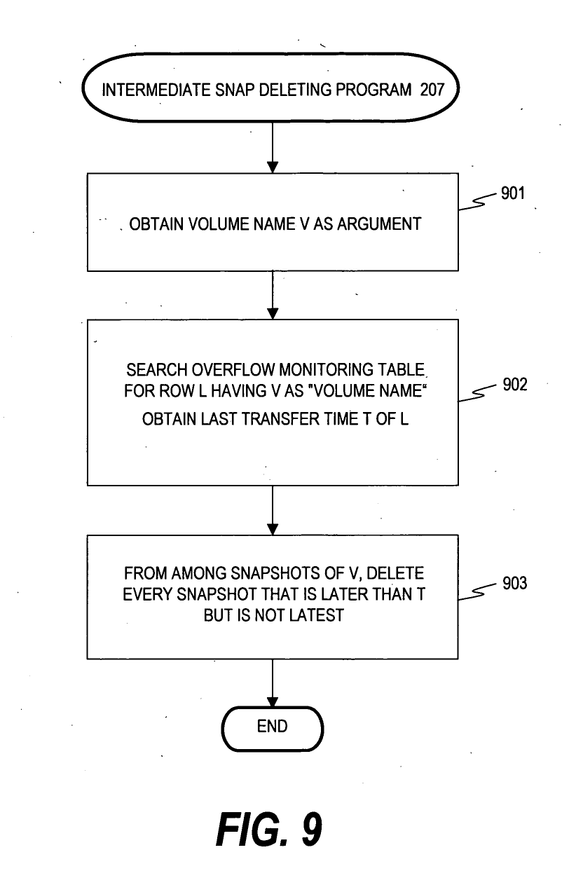

The deletion of an intermediate snapshot is executed in Step 903 of FIG. 9 as will be described later.

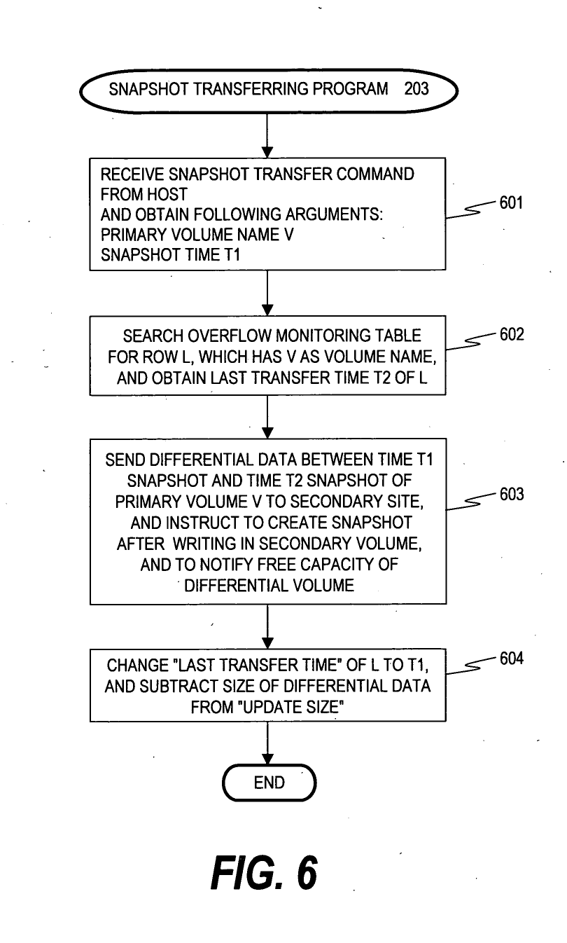

FIG. 6 is a flow chart for the snapshot transferring program 203 according to the embodiment of this invention.

The flow chart of FIG. 6 shows processing implemented by executing the snapshot transferring program 203 with the processor 116.

First, in Step 601, the processor 116 receives a snapshot transfer command sent by the host 111 to the storage system 112, and obtains as arguments a volume name V and a created time T1 of a snapshot to be transferred.

In Step 602, the processor 116 searches the overflow monitoring table 209 for a row L, which has “V” as the volume name 301. Then the processor 115 obtains a value “T2” registered as the last transfer time 302 in the row L.

In Step 603, the processor 116 sends differential data of two snapshots of the volume V to the storage system 122 of the secondary site 2. The two snapshots of the volume V here are a snapshot created at a time T1 and a snapshot created at a time T2. For example, in the case where the snapshots 503 and 504 shown in FIG. 5 are created and the value T2 registered as the last transfer time 302 is 9:00 as shown in FIG. 3, data of the snapshot 503 created at 9:00 has already been transferred to the secondary site 2 whereas the subsequently updated data Y is yet to be transferred to the secondary site 2. The processor 116 accordingly instructs the storage system 122 of the secondary site 2 to write the differential data in the secondary volume 124. The differential data in Step 603 is differential data of the two snapshots at the time T1 and T2, and corresponds to the data Y in the above specific example.

The processor 116 then gives the storage system 122 of the secondary site 2 a further instruction to create a snapshot and notify a free capacity remaining after the creation in the differential volume 125 of the secondary site 2. A snapshot is created by executing the snapshot creating program 201 with the processor 116.

In Step 604, the processor 116 changes the value in the field for the last transfer time 302 of the row L to T1. The processor 116 subtracts the size of the differential data transferred in Step 603 from a value in the field for the update size 303 of the row L.

This completes the processing of the snapshot transferring program 203.

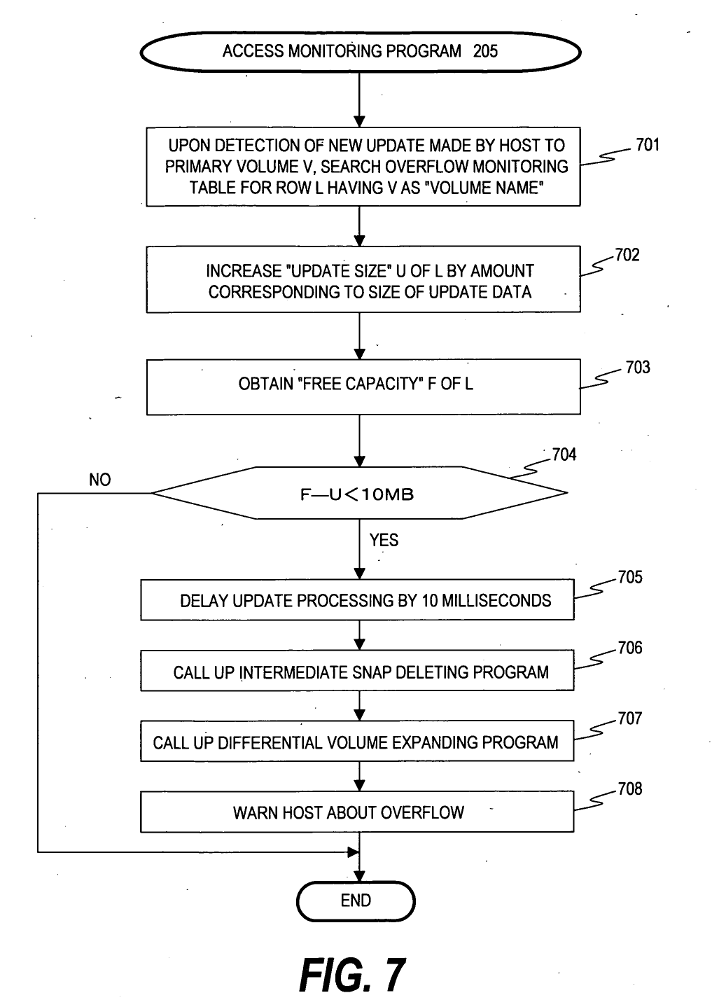

FIG. 7 is a flow chart for the access monitoring program 205 according to the embodiment of this invention.

The flow chart of FIG. 7 shows processing implemented by executing the access monitoring program 205 with the processor 116.

First, in Step 701, the processor 116 detects a new update made by the host 111 to the storage system 112. The new update here is a write request issued by the host 111 to the storage system 112 to write in the primary volume 114. Detecting the new update, the processor 116 searches the overflow monitoring table 209 with the name “V” of the primary volume 114 as a key, and obtains as a result a row L that has “V”, in the field for the volume name 301.

In Step 702, the processor 116 increases a value U registered as the update size 303 of the row L by an amount corresponding to the size of the update data.

In Step 703, the processor 116 obtains a value F as the free capacity 304 of the row L.

In Step 704, the processor 116 predicts whether or not data overflow will happen in the differential volume 125. Specifically, the processor 116 calculates a subtraction, F−U, and judges whether or not the difference is smaller than a threshold 10 MB. When F−U is smaller than 10 MB, a shortage of capacity of the differential volume 125 and resultant data overflow of the differential volume 125 are predicted. In this case, the processor 116 proceeds to Step 705 to execute processing of preventing data overflow. When F−U is equal to or larger than 10 MB, on the other hand, the differential volume 125 has enough free capacity and it is therefore predicted that data overflow will not happen. In this case, the processor 116 ends the processing. The threshold in Step 704 which is 10 MB in this embodiment may be set to other values than 10 MB.

Steps 705 to 708 are processing executed by the processor 116 in order to prevent data overflow of the differential volume 125.

In Step 705, the processor 116 delays update processing by 10 milliseconds. The update processing here is processing in which the processor 116 writes data in the primary volume 114 in response to a data write request issued by the host 111. As a result of executing Step 705, a latency of 10 milliseconds is inserted to the processing in which the processor 116 writes data in the primary volume 114. The time since the reception of the write request by the processor 116 until the write processing is finished is thus prolonged by 10 milliseconds. The delay time in Step 705 which in this embodiment is 10 milliseconds may be shorter or longer than 10 milliseconds. Delaying update processing in Step 705 prevents data overflow.

In Step 706, the processor 116 calls up the intermediate snap deleting program 207 with “V” as an argument. The intermediate snap deleting program 207 is executed by the processor 116 in order to prevent data flow as shown in FIG. 9.

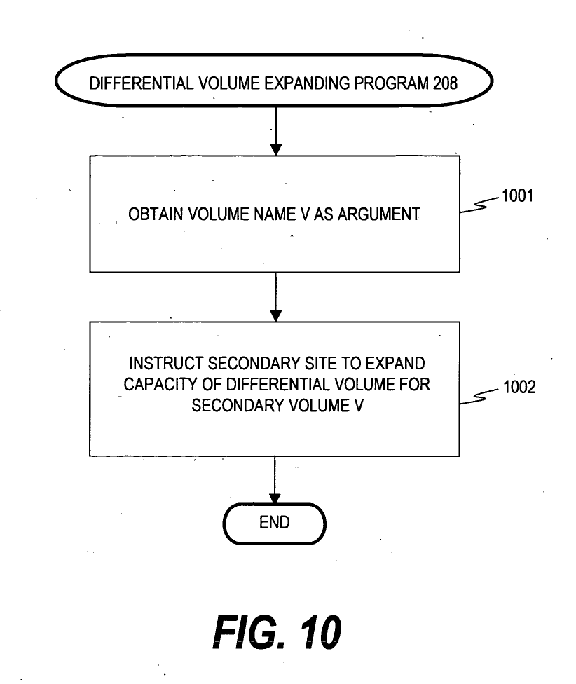

In Step 707, the processor calls up the differential volume expanding program 208 with “V” as an argument. The differential volume expanding program 208 is executed by the processor 116 in order to prevent data overflow as shown in FIG. 10.

In Step 708, the processor sends a warning about a possibility of data overflow to the host 111. A user of the host 111 may execute processing of preventing data flow upon seeing the warning.

The processor 116 may execute the above four types of processing of Steps 705 to 708. Alternatively, the processor 116 may execute one or some of the above four types of processing. An arbitrary order can be employed, by the processor 116 in executing one or some of the above four types of processing.

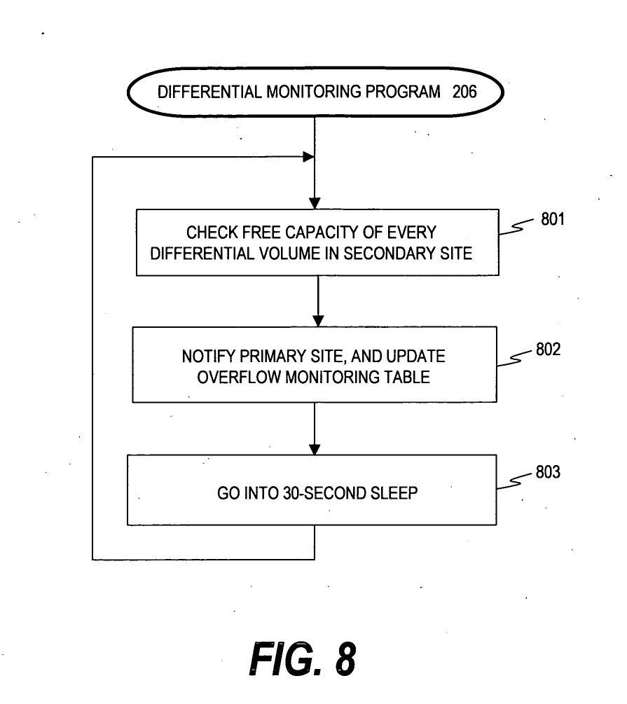

FIG. 8 is a flow chart for the differential monitoring program 206 according to the embodiment of this invention.

The flow chart of FIG. 8 shows processing implemented by executing the differential monitoring program 206 with the processor 116. The differential monitoring program 206 is activated when the storage system 122 is powered on and keeps operating since then without being shut down.

First, in Step 801, the processor 116 checks the free capacity of every differential volume 125 provided in the storage system 122 of the secondary site 2.

In Step 802, the processor 116 notifies the storage system 112 of the primary site 1 of the free capacity obtained in Step 801 to make the storage system 112 update the overflow monitoring table 209.

In Step 803, the processor 116 goes into a 30-second sleep and then returns to Step 801. The length of the sleep may be shorter or longer than 30 seconds.

The series of processing shown in FIGS. 6 to 8 is processing of detecting a data overflow risk.

Described next with reference to FIGS. 9 and 10 is processing that is executed as overflow preventing processing when a data overflow risk is detected.

FIG. 9 is a flow chart for the intermediate snap deleting program 207 according to the embodiment of this invention.

The flow chart of FIG. 9 is processing implemented by executing the intermediate snap deleting program 207 with the processor 116.

First, in Step 901, the intermediate snap deleting program 207 is called by the access monitoring program 205 at the Step 706, and the processor 116 obtains the volume name “V” as an argument.

In Step 902, the processor 116 searches the overflow monitoring table 209 for the row L that has “V” as the volume name 301, and obtains a value “T” as the last update time 302 of the row L.

In Step 903, the processor 116 deletes every snapshot that is created later than the time T and that is not the latest snapshot among snapshots of the volume V. Specifically, the processor 116 calls up the snapshot deleting program 202 to delete every snapshot that meets the above conditions.

To delete a snapshot of the primary site 1 shown in FIG. 5, the processor 116 calls up the snapshot deleting program 202 of the primary site 1. To delete a snapshot of the secondary site 1, the processor 116 calls up the snapshot deleting program 202 of the secondary site 2 by sending an instruction to the controller 123 of the secondary site 2.

When the snapshot deleting program 202 of the primary site 1 is called up, the snapshot deleting program 202 deletes, from the differential volume 115, every data contained only in snapshots that meet the above conditions. As a result, less data is transferred from the primary site 1 to the secondary site 2.

When the snapshot deleting program 202 of the secondary site 2 is called up, the snapshot deleting program 202 deletes, from the differential volume 125, every data contained only in snapshots that meet the above conditions. This increases the free capacity of the differential volume 125. Thus, the execution of the processing shown in FIG. 9 prevents data overflow of the differential volume 125.

FIG. 10 is a flow chart for the differential volume expanding program 208 according to the embodiment of this invention.

The flow chart of FIG. 10 shows processing implemented by executing the differential volume expanding program 208 with the processor 116.

First, in Step 1001, the differential volume expanding program 208 is called by the access monitoring program 205 at the Step 707, and the processor 116 obtains the volume name “V” as an argument.

In Step 1002, the processor 116 instructs the controller 123 in the storage system 122 of the secondary site 2 to expand the volume size of the differential volume 125 that is associated with the secondary volume 124 to which data of the volume V is copied. As a result, the free capacity of the differential volume 125 is increased and data overflow is prevented.

Details of the storage systems 112 and 122 have been described in the above. Now, the flow of remote copy operation using the storage systems 112 and 122 will be described as well as the position the overflow detection processing takes in the remote copy operation. The description given below is premised on the following operation scenario.

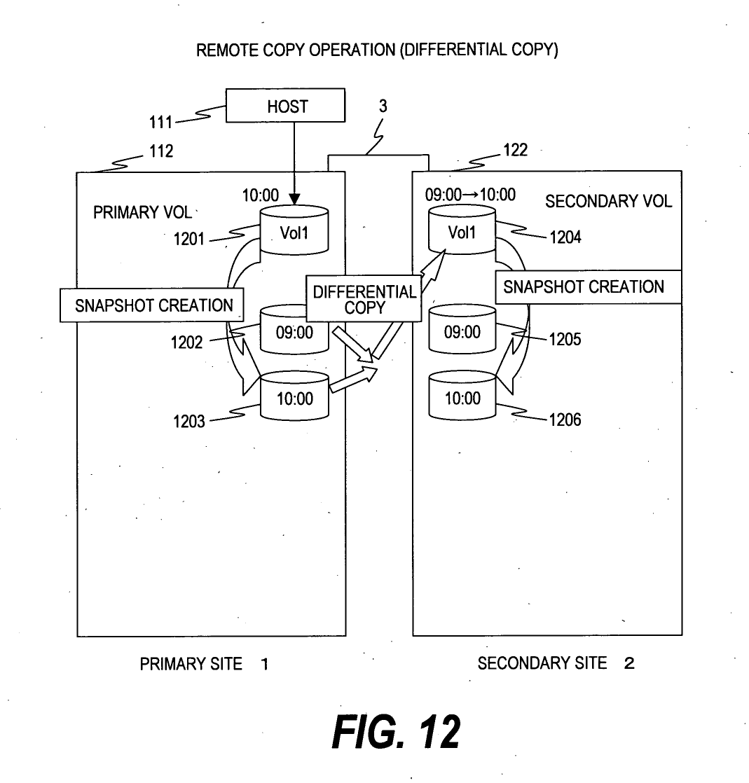

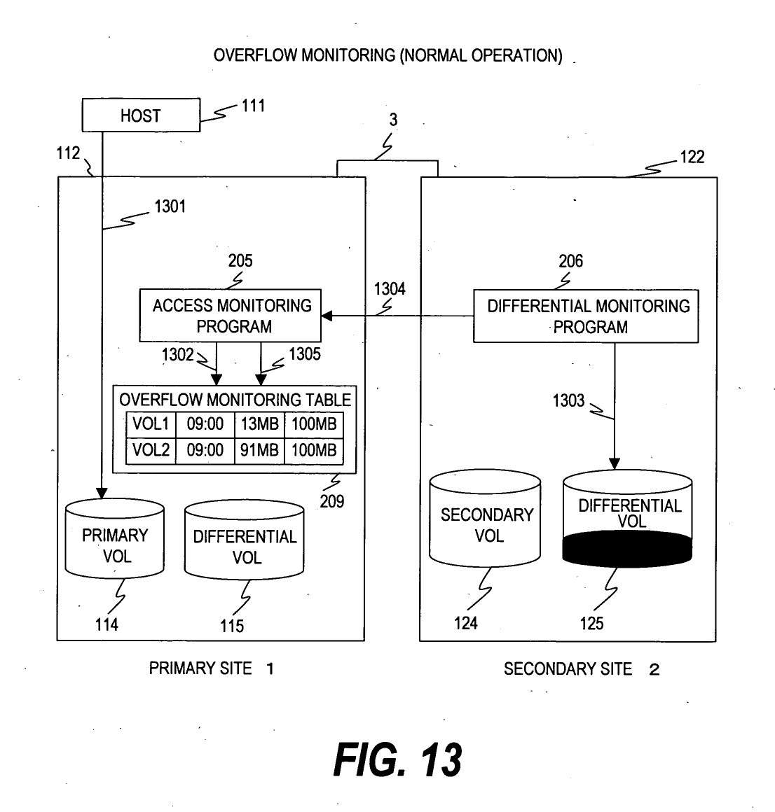

First, preparations for remote copy are finished by 9:00 as shown in FIG. 11. Next, the remote copy operation is started at 09:01, and is run normally until 09:59. At 10:00, differential copy processing takes place as shown in FIG. 12. The differential copy processing is executed regularly (every hour, for example). Lastly, normal remote copy operation from 10:01 to 10:09 is followed by overflow monitoring processing at 10:10 as shown in FIG. 13.

FIG. 11 is an explanatory diagram of remote copy preparations according to the embodiment of this invention.

Specifically, FIG. 11 shows as an example the flow of remote copy preparations (i.e. full copy) at 09:00.

As shown in FIG. 11, the two storage systems 112 and 122 are connected to each other through the network 3. The storage system 112 of the primary site 1 serves as a copy source whereas the storage system 122 of the secondary site 2 serves as a copy destination. In the primary site 1, the host 111 is using a primary volume 1101 (Vol1). In other words, the primary volume 1101 is an operational volume. Data stored in the primary volume 1101 of the primary site 1 is remote-copied to a secondary volume 1103 (Vol1) of the secondary site 2 through a procedure described below. The primary volume 1101 and the secondary volume 1103 respectively correspond to the primary volume 114 and the secondary volume 124, which are shown in FIGS. 1 and 2. The volumes in FIG. 11 are denoted by reference symbols different from their counterparts in FIGS. 1 and 2 for convenience's sake in the explanation of the procedure. Differential data of created snapshots is stored in the differential volumes 115 and 125 of the storage systems 112 and 122.

First, an administrator of the primary site 1 gives via the host 111 an instruction to create a snapshot 1102 of the primary volume 1101. Receiving the instruction, the snapshot creating program 201 of the storage system 112 creates the snapshot 1102, which is a snapshot of the volume 1101 (Vol1) at 09:00.

Next, the primary site administrator gives a full copy instruction to the storage system 112 via the host 111. Receiving the instruction, the storage system 112 transfers all data of the snapshot 1102 to the storage system 122 of the secondary site 2 to write the transferred data in the secondary volume 1103 of the secondary site 2.

Lastly, an administrator of the secondary site gives an instruction to create a snapshot to the storage system 122 via the host 121. Receiving the instruction, the storage system 122 of the secondary site 2 activates the snapshot creating program 201 and creates a snapshot 1104 of the secondary volume 1103. At the time this procedure is completed, the two sites, primary and secondary, have common snapshots 1102 and 1104 of 09:00. The secondary volume 1103 of the secondary site 2 at this point has the same data that is found at 9:00 in the primary volume 1101. In other words, the secondary volume 1103 is synchronized with the primary volume 1101 of the primary site 1.

Executing full copy first in the manner described above makes yields the snapshots 1102 and 1104, which are common to the primary and secondary sites. This makes it possible to subsequently carry out remote copy through differential copy that uses the common snapshots 1102 and 1104. The storage systems 112 and 122 of the primary and secondary sites add a row for the volume Vol1 to the overflow monitoring table 209, and register “Vol1” and “09:00” as the volume name 301 and as the last transfer time 302, respectively, in the added row.

A point that should be noted here is that full copy processing in which every data in a volume is transferred is very time-consuming. It is not until the full copy processing is completed that disaster recovery can be started. The full copy processing can be sped up by employing a high-speed network as the network 3, which connects the primary and secondary sites. However, such a high-speed network would be excessively above specification for normal differential copy operation described later, and would lower the network utilization efficiency. In other words, it would raise the cost of the remote copy operation.

The primary volume 1101 and the secondary volume 1103 in FIG. 11 correspond to the operational volume 501 of FIG. 5. The snapshots 1102 and 1104 in FIG. 11 correspond to the first generation snapshot 503 of FIG. 5.

FIG. 12 is an explanatory diagram of remote copy operation according to the embodiment of this invention.

Specifically, FIG. 12 shows as an example the flow of remote copy operation at 10:00. A primary volume 1201 and a secondary volume 1204 in FIG. 12 respectively correspond to the primary volume 114 and the secondary volume 124, which are shown in FIGS. 1 and 2.

In the primary site 1, the snapshot creating program 201 and the snapshot transferring program 203 are activated hourly so that remote copy processing is periodically executed. The remote copy processing employs the following procedure to copy a part of data in the primary volume 1201 of the primary site 1 to the secondary volume 1204 of the secondary site 2 to synchronize the secondary volume 1204 with the primary volume 1201. This type of copy is called differential copy.

First, in the primary site 1, the snapshot creating program 201 creates a snapshot 1203 of the primary volume 1201 at 10:00.

Next, the snapshot transferring program 203 is activated in the primary site 1. Activation of the snapshot transferring program 203 is timed with, for example, the completion of snapshot creating processing by the snapshot creating program 201.

The snapshot transferring program 203 transfers, as has been described with reference to FIG. 6, differential data between the snapshot 1202 at 9:00 and the snapshot 1203 at 10:00 to the storage system 122 of the secondary site 2. For instance, in the case where the snapshot 1202 at 9:00 corresponds to the first generation snapshot 503 of FIG. 5 and the snapshot 1203 at 10:00 corresponds to the second generation snapshot 504 of FIG. 5, “Y”, which is differential data of the two, is transferred to the secondary site 2.

The snapshot transferring program 203 updates the last transfer time 302 to “10:00” in a row that is set in the overflow monitoring table 209 for the primary volume 1201.

At the time this procedure has been completed, the secondary volume 1204 holds the same data that is stored at 10:00 in the primary volume 1201. Obtained as a result are two pairs of snapshots common to the primary and secondary sites, one being the snapshots 1202 and 1205 at 09:00 and the other being the snapshots 1203 and 1206 at 10:00.

As described above, setting common snapshots as a basing point makes it possible to execute differential copy and, furthermore, to obtain a new common snapshot pair. The old common snapshot pair can be deleted after the new common snapshot pair is obtained without causing a problem in executing subsequent differential copy. Remind that if the primary volume 1201 is kept updated without deleting old snapshots, sooner or later no free capacity is left in the differential volumes 115 and 125, which leads to loss of every snapshot. The loss of snapshots makes it necessary to execute full copy all over again. This means a prolonged unsafe state in which disaster recovery is not possible, and considerably lowers a business' ability to continue its operation.

FIG. 13 is an explanatory diagram of overflow monitoring according to the embodiment of this invention.

FIG. 13 illustrates the procedure of normal overflow monitoring at 10:00 as an example. Execution of overflow monitoring is timed with an update 1301 made by the host 111 to the primary site 1, while the differential monitoring program 206 in the secondary site 2 executes overflow monitoring regularly. These two cases will be described below.

Described first is the case in which execution of overflow monitoring is timed with an update made by the host 111.

When the host 111 makes the update 1301 to the primary volume 114 in the primary site 1, the access monitoring program 205 is activated. The access monitoring program 205 checks the size of the update 1301 (i.e., the size of data written through the update), and adds the obtained update size to a value registered as the update size 303 of a row for the updated volume in the overflow monitoring table 209 (1302). At this point, the access monitoring program 205 also checks the free capacity 304. In the case where the calculation in Step 704 reveals that there is not enough free capacity (in other words, the risk of overflow), the access monitoring program 205 calls up the intermediate snap deleting program 207 and the differential volume expanding program 208 (Steps 706 and 707 of FIG. 7) to increase the free capacity of the differential volume 125 of the secondary site 2. In addition, processing of the update 1301 is delayed to thereby hold off overflow while the above measure of increasing the free capacity is underway (Step 705 of FIG. 7).

Described next is the case of executing overflow monitoring regularly.

In the secondary site 2, the differential monitoring program 206 is activated regularly to check every differential volume 125 in the storage system 122 and obtain its free capacity (1303). The differential monitoring program 206 notifies the storage system 112 of the primary site 1 of the obtained free capacity. The access monitoring program 205 of the storage system 112 adds the free capacity obtained from the storage system 122 of the secondary site 2 to the free capacity 304 in the overflow monitoring table 209 of the storage system 112 (1305).

Data overflow in the differential volume 115 of the primary site 1 happens always before data overflow in the differential volume 125 of the secondary site 2 as long as the differential volume 115 of the primary site 1 and the differential volume 125 of the secondary site 2 have the same capacity and snapshots of the same generation are held in the primary site 1 and the secondary site 2. However, a snapshot of the primary site 1 is usually created for the purpose of improving the remote copy efficiency by transferring only differential data, whereas the secondary site 2 manages backup data by generation, with the result that the secondary site 2 usually holds snapshots of more generations than the primary site 1 does. Accordingly, in some cases, data overflow happens in the differential volume 125 of the secondary site 2 despite the differential volume 115 of the primary site 1 having enough free capacity.

In the embodiment of this invention, the free capacity of the differential volume 125 is monitored in the secondary site 2 and information on the free capacity is sent to the primary site 1 as shown in FIG. 13. The primary site 1 predicts, from the free capacity sent from the secondary site 2 and the size of differential data about to be transferred to the secondary site 2, data overflow in the differential volume 125 before it actually happens. The predicted data overflow is avoided by delaying update processing, deleting an intermediate snapshot, increasing the capacity of the differential volume 125, notifying the host 111 of the predicted data overflow, or the like.

The embodiment of this invention described above is applicable to, for example, a storage system having a remote copy function with which a disaster recovery system can be built, and disaster recovery. The embodiment of this invention is particularly well applied to NAS and the like.

What is claimed is:

1. A computer system, comprising:
a host computer;
a first storage system coupled to the host computer; and
a second storage system coupled to the first storage system,
wherein the first storage system comprises a first volume, a second volume, and a first controller, the first volume storing data that is written by the host computer, the second volume storing data that has been stored in a block in the first volume when the block is to be updated, the first controller controlling the first storage system,
wherein the second storage system comprises a third volume, a fourth volume, and a second controller, the third volume storing data that is copied from the first volume, the fourth volume storing data that has been stored in a block in the third volume when the block is to be updated, the second controller controlling the second storage system, and
wherein the first controller predicts whether or not the fourth volume becomes short of capacity and, predicting that the fourth volume becomes short of capacity, delays data write processing in which the host computer writes data in the first volume by a given period of time.

2. The computer system according to claim 1,
wherein the second controller checks how much free capacity the fourth volume has, and sends information on the obtained free capacity to the first storage system,
wherein the first controller subtracts an amount of data written in the first volume by the host computer from the free capacity contained in the information received from the second controller, and
wherein, when a result of the subtraction is smaller than a given threshold, the first controller predicts that the fourth volume becomes short of capacity.

3. The computer system according to claim 2,
wherein the first controller manages, as snapshots of plural generations, data stored in the first volume and the second volume, and
wherein, when the fourth volume is predicted to become short of capacity, the first controller deletes, instead of delaying the data write processing by a given period of time, from the second volume, data that is contained only in one or more snapshots of intermediate generations excluding snapshots of the oldest and latest generations.

4. The computer system according to claim 2,
wherein the second controller manages, as snapshots of plural generations, data stored in the third volume and the fourth volume, and
wherein, when the fourth volume is predicted to become short of capacity, the first controller sends, instead of delaying the data write processing by a given period of time, an instruction to the second controller which instructs to delete, from the fourth volume, data that is contained only in one or more snapshots of intermediate generations excluding snapshots of the oldest and latest generations.

5. The computer system according to claim 2,
wherein, when the fourth volume is predicted to become short of capacity, the first controller sends, instead of delaying the data write processing by a given period of time, an instruction to the second storage system which instructs to expand the capacity of the fourth volume.

6. The computer system according to claim 2,
wherein, when the fourth volume is predicted to become short of capacity, the first controller sends, instead of delaying the data write processing by a given period of time, a warning to the host computer.

7. A storage system coupled to a host computer and to another storage system, comprising
a first volume for storing data that is written by the host computer;
a second volume for storing data that has been stored in a block in the first volume when the block is to be updated; and
a controller for controlling the storage system,
wherein the other storage system comprises a third volume for storing data that is copied from the first volume and a fourth volume for storing data that has been stored in a block in the third volume when the block is to be updated, and
wherein the controller predicts whether or not the fourth volume becomes short of capacity and, predicting that the fourth volume becomes short of capacity, delays data write processing in which the host computer writes data in the first volume by a given period of time.

8. The storage system according to claim 7,
wherein the controller receives, from the other storage system, information about how much free capacity the fourth volume has, and subtracts an amount of data written in the first volume by the host computer from the free capacity contained in the received information, and
wherein, when a result of the subtraction is smaller than a given threshold, the controller predicts that the fourth volume becomes short of capacity.

9. The storage system according to claim 8,
wherein the controller manages, as snapshots of plural generations, data stored in the first volume and the second volume, and
wherein, when the fourth volume is predicted to become short of capacity, the controller deletes, instead of delaying the data write processing by a given period of time, from the second volume, data that is contained only in one or more snapshots of intermediate generations excluding snapshots of the oldest and latest generations.

10. The storage system according to claim 8,
wherein the other storage system manages, as snapshots of plural generations, data stored in the third volume and the fourth volume, and
wherein, when the fourth volume is predicted to become short of capacity, the controller sends, instead of delaying the data write processing by a given period of time, an instruction to the other storage system which instructs to delete, from the fourth volume, data that is contained only in one or more snapshots of intermediate generations excluding snapshots of the oldest and latest generations.

11. The storage system according to claim 8,
wherein, when the fourth volume is predicted to become short of capacity, the controller sends, instead of delaying the data write processing by a given period of time, an instruction to the other storage system which instructs to expand the capacity of the fourth volume.

12. The storage system according to claim 8,
wherein, when the fourth volume is predicted to become short of capacity, the controller sends, instead of delaying the data write processing by a given period of time, a warning to the host computer.

13. A control method for a computer system comprising:
a host computer;
a first storage system coupled to the host computer; and
a second storage system coupled to the first storage system,
wherein the first storage system comprises a first volume, a second volume, and a first controller, the first volume storing data that is written by the host computer, the second volume storing data that has been stored in a block in the first volume when the block is to be updated, the first controller controlling the first storage system,
wherein the second storage system comprises a third volume, a fourth volume, and a second controller, the third volume storing data that is copied from the first volume, the fourth volume storing data that has been stored in a block in the third volume when the block is to be updated, the second controller controlling the second storage system,
the control method comprising:
predicting, by the first controller, whether or not the fourth volume becomes short of capacity; and
when predicting that the fourth volume becomes short of capacity, delaying, by the first controller, data write processing in which the host computer writes data in the first volume by a given period of time.

14. The control method according to claim 13, further comprising:
checking, by the second controller, how much free capacity the fourth volume has, and sending, by the second controller, information on the obtained free capacity to the first storage system;
subtracting, by the first controller, an amount of data written in the first volume by the host computer from the free capacity contained in the information received from the second controller; and
when a result of the subtraction is smaller than a given threshold, predicting, by the first controller, that the fourth volume becomes short of capacity.

15. The control method according to claim 14,
wherein the first controller manages, as snapshots of plural generations, data stored in the first volume and the second volume,
the control method further comprising
when the fourth volume is predicted to become short of capacity, deleting, by the first controller, instead of delaying the data write processing by a given period of time, from the second volume, data that is contained only in one or more snapshots of intermediate generations excluding snapshots of the oldest and latest generations.

16. The control method according to claim 14,
wherein the second controller manages, as snapshots of plural generations, data stored in the third volume and the fourth volume,
the control method further comprising
when the fourth volume is predicted to become short of capacity, sending, by the first controller, instead of delaying the data write processing by a given period of time, an instruction to the second controller which instructs to delete, from the fourth volume, data that is contained only in one or more snapshots of intermediate generations excluding snapshots of the oldest and latest generations.

17. The control method according to claim 14, further comprising
when the fourth volume is predicted to become short of capacity, sending, by the first controller, instead of delaying the data write processing by a given period of time, an instruction to the second storage system which instructs to expand the capacity of the fourth volume.

18. The control method according to claim 14, further comprising
when the fourth volume is predicted to become short of capacity, sending, by the first controller, instead of delaying the data write processing by a given period of time, a warning to the host computer.
